(19) United States
(12) Patent Application Publication
(10) Pub. No.: US 2006/0290214 A1
(43) Pub. Date: Dec. 28, 2006

(54) Dynamo electric machine with a brushless exciter

(75) Inventors: Lennart Diestel-Feddersen, Brugg (CH); Alberto Izquierdo, Nussbaumen (CH)

Correspondence Address: BUCHANAN, INGERSOLL & ROONEY PC, POST OFFICE BOX 1404, ALEXANDRIA, VA, 22313-1404, US

(73) Assignee: ALSTOM Technology Ltd, Baden (CH)

(21) Appl. No.: 11/447,111

(22) Filed: Jun. 6, 2006

(30) Foreign Application Priority Data
Jun. 7, 2005 (CH) 00956/05

(51) Int. Cl. H02K 11/04; H02K 19/36

(52) U.S. Cl. 310/68 D

(57) ABSTRACT

The invention relates to a dynamo electric machine with a brushless exciter which comprises an exciter rotor driven by the rotor of the dynamo electric machine, and an exciter stator interacting with the exciter rotor. The design of the machine with respect to cooling is facilitated by cooling the exciter with a gaseous cooling medium, particularly air, by means of an independent cooling circuit, and by providing a separate fan for circulating the gaseous cooling medium within the cooling circuit of the exciter.

### RELATED APPLICATION

The present application claims priority under 35 USC §119 to Swiss Patent Application No. 00956/05, filed Jun. 7, 2005, the contents of which are hereby incorporated by reference in their entirety.

1. Technical Field

The present invention relates to the field of dynamo electric machines. It relates to a dynamo electric machine according to the preamble of claim 1.

2. Prior Art

In large dynamo electric machines, particularly generators, frequently installed at one end of the rotor is a brushless exciter, which acts as alternating-voltage generator and internally rectifies the alternating current generated and feeds it into the winding located on the rotor for exciting the machine. In the case of high powers, the machine itself has a cooling circuit, within which a gaseous cooling medium, particularly air, is sent through the rotor and stator and the air gap existing between the two and the heat absorbed there is removed again in internal cooling devices (coolers, heat exchangers etc.). To circulate the cooling medium, fans or ventilators are usually arranged on the rotor shaft at both ends of the rotor. Since considerable heat is also produced in the exciter, at the windings and the power semiconductors used for rectification there and the internal ventilation of the exciter is inadequate, cooling of the exciter is necessary in many cases.

In the hitherto known solutions for cooling the exciter, the cooling circuit provided for this purpose was integrated in the cooling circuit of the machine or of the generator, respectively. The approach most frequently used consists in sending the cooling medium through the exciter after it has already passed the winding heads of the machine winding (the cooling medium flows from the machine fan to the winding head and from there to the exciter). Such a solution is disclosed, for example, in U.S. Pat. No. 3,643,119. After the cooling medium has cooled the exciter, it is returned to the cooling device of the machine.

However, such simple cooling circuits have some disadvantages:
(1) The cooling medium for the exciter is already heated. For standard conditions of a cooling medium temperature in a machine of 40° C., the inlet temperature at the exciter is then about 60° C. This reduces the possible performance of the machine.
(2) Since the exciter is integrated into the cooling circuit of the machine, the throughput of the cooling medium through the exciter depends on the total cooling circuit of the machine. If the design of the machine deviates from the standard (in the coolers, the foundations, the tubing, the angle of attack of the fan blades etc.), the throughput of the cooling medium through the exciter can only be predicted with difficulty. This has two possible consequences:
   overdimensioned exciters
   exciter with a risk of excessive temperatures.

The disadvantage listed at (2) also applies to the known solutions in which the cooling medium for cooling the exciter is branched off before it has absorbed heat at the winding heads (see, e.g., U.S. Pat. No. 4,745,315 or U.S. Pat. No. 4,904,890).

### BRIEF DESCRIPTION OF THE INVENTION

It is the object of the invention to create a dynamo electric machine with cooled brushless exciter which avoids the disadvantages of the known machines and is distinguished, in particular, by an optimally planable and adjustable cooling of the exciter.

The object is achieved by the totality of the features of claim 1. This solution is characterized by an independent cooling circuit of the exciter in which a separate fan is provided for the circulation of the gaseous cooling medium. The separate fan can be optimally adjusted to the requirements of the exciter cooling within the independent cooling circuit without having to consider the design of the dynamo electric machine itself.

An embodiment of the invention is characterized by the fact that the exciter is arranged axially behind the rotor of the dynamo electric machine, that an axially acting fan is provided which conveys the gaseous cooling medium axially through the exciter, that exciter rotor and exciter stator are arranged coaxially with respect to the rotor of the dynamo electric machine, that the fan is arranged between the exciter and the rotor, and that the fan conveys the gaseous cooling medium axially through the exciter rotor, the exciter stator and the intermediate space between exciter rotor and exciter stator. This results in a very compact construction of the cooled exciter.

In this arrangement, the exciter rotor is preferably connected to the rotor shaft of the rotor and the fan is arranged on the rotor shaft or an extension of the rotor shaft.

Another embodiment is characterized by the fact that the exciter rotor encloses the exciter stator concentrically, that the exciter rotor is mounted on the inside of a concentric retaining ring, and that the retaining ring encloses the fan, forming an annular cooling air channel between the rotor shaft carrying the fan, or its extension, respectively, and the retaining ring.

In particular, the retaining ring comprises a circular-disk-shaped wall which is perpendicular to the axis and arranged between the fan and the exciter, by means of which the retaining ring is mounted on the rotor shaft or the extension, respectively, wherein cooling air openings are provided distributed over the circumference in the wall, through which the cooling medium can flow axially between the fan and the exciter.

The exciter rotor has an armature winding, the exciter stator has a field winding. Axial cooling ducts, through which the cooling medium flows, are provided in the exciter rotor and in the exciter stator. In addition to the axial cooling ducts, radial cooling ducts can be provided in the exciters through which the cooling medium flows to the outside.

Between the wall and the exciter rotor, on the inside of the retaining ring, power semiconductors interconnected to the exciter are preferably arranged in such a manner that they are located in the flow of the cooling medium passing through the cooling air openings.

Another embodiment of the invention is characterized by the fact that the exciter stator is mounted on a mounting wall which is perpendicular to the axis and is arranged axially behind the retaining ring, and that, for the outlet of the cooling medium flowing through the exciter, cooling air openings are provided in the mounting wall and/or a radial cooling air outlet is provided between the retaining ring and the mounting wall.

A radial cooling air inlet, through which the cooling medium is supplied to the fan, can be provided, in particular, in front of the fan in the flow direction.

It is conceivable that the cooling circuit of the exciter is constructed as a cooling circuit closed in itself and comprises a separate cooling device. In this case, the cooling circuits are completely decoupled. For this purpose, the exciter can be enclosed by a cooling air housing which forms a collecting space surrounding the exciter, the cooling device being arranged adjoining the collecting space and the cooling device being connected at its input with the collecting space and at its output with the fan. However, it is also conceivable that the dynamo electric machine has a separate cooling circuit and a separate cooling device and that the cooling circuit of the exciter also uses the cooling device of the dynamo electric machine.

For applications with dual drive, it is finally possible that the exciter stator has a central through bore in the axial direction and that a connecting shaft is carried through the through bore from the rotor of the dynamo electric machine to the other side of the exciter.

### BRIEF EXPLANATION OF THE FIGURES

In the text which follows, the invention will be explained in greater detail by means of exemplary embodiments and in conjunction with the drawing, in which:

FIG. 1 shows in a diagrammatic longitudinal section the exciter of a dynamo electric machine according to a first exemplary embodiment of the invention with purely axial flow of the cooling medium;

FIG. 2 shows in a representation comparable to FIG. 1 an exciter according to a second exemplary embodiment of the invention with radial guidance of the cooling medium on the outlet side;

FIG. 3 shows in a representation comparable to FIG. 2 an exciter according to a third exemplary embodiment of the invention with a connecting shaft, conducted centrally through the exciter, for applications with dual drive and a radial inlet of the cooling medium;

FIG. 4 shows the exciter of FIG. 2 in a separate closed cooling circuit with separate cooling device for the exciter;

FIG. 5 shows in a top view the wall of the retaining ring from FIGS. 1-4 with the cooling air openings arranged therein; and

FIG. 6 shows a complete dynamo electric machine with exciter and an exciter cooling circuit which also uses the cooling device of the machine according to a further exemplary embodiment of the invention.

### APPROACHES FOR CARRYING OUT THE INVENTION

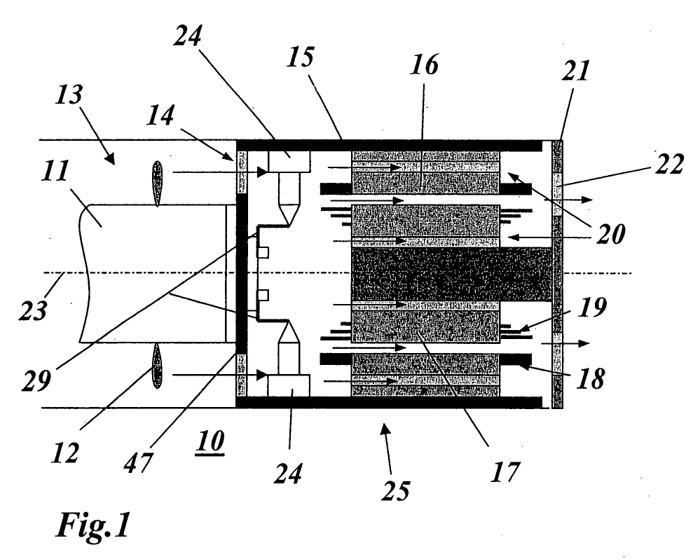

FIG. 1 shows the exciter of a dynamo electric machine according to a first exemplary embodiment of the invention in a diagrammatic longitudinal section. Apart from the exciter 25, only the right-hand end section of the rotor shaft 11 or an extension of the rotor shaft of the dynamo electric machine 10 can be seen. The exciter 25 comprises a hollow-cylindrical retaining ring 15 which is closed at one (left-hand) end with a wall 47 in the form of a circular disk. The retaining ring 15 is flanged (coupling parts 37 in FIG. 5) at the front end of the rotor shaft 11 or the extension concentrically to the rotor shaft 11 with the wall 47 and correspondingly rotates with the rotor shaft 11 about the axis 23. Within the retaining ring 15, the exciter rotor 16 with an armature winding 18 is arranged rotating on the inside wall. The exciter rotor 16 concentrically surrounds the central exciter stator 17 which is equipped with a field winding 19 and which is mounted on a stationary mounting wall 21. Between the mounting wall 21 and retaining ring 15, suitable seals are provided. In a space remaining free between exciter rotor 16 and wall 47, power semiconductors 24 in the form of diodes are arranged at the inside wall of the retaining ring 15, which rectify the alternating voltage induced in the armature winding 18 and forward it via connecting conductors 29 on feed lines running along the interior of the rotor shaft 11 to the rotor winding of the machine (central opening 36 in FIG. 5).

In the example of FIG. 1, the exciter 25 is cooled by an axial flow of a gaseous cooling medium, particularly cooling air, which flows from left to right through the exciter 25 in the direction of the arrows drawn. The flow of the cooling medium is generated by a fan 12 which is mounted directly on the rotor shaft 11 and is only responsible for cooling the exciter 25. The fan 12 is concentrically enclosed by the retaining ring 15 so that an annular cooling air channel 13 is formed between the retaining ring 15 and the rotor shaft 11 through which the cooling medium is conveyed by the fan 12. In the wall 47 of the retaining ring 15, cooling air openings 14 (FIG. 5), through which the cooling medium conveyed by the fan 12 can enter the exciter 25 axially are provided distributed over the circumference. Immediately behind the cooling air openings 14 in the flow direction, the cooling medium flowing in encounters the diodes 24 and absorbs the heat produced there. The cooling medium then axially passes through axial cooling ducts 20 in the exciter rotor 16 and the exciter stator 17 and through the air gap between the exciter rotor 16 and exciter stator 17. After flowing through the cooling ducts 20 and the air gap, respectively, the cooling medium passes through cooling air openings 22 in the mounting wall 21 out of the exciter 25 and can be conducted to a cooling device which is not shown in FIG. 1.

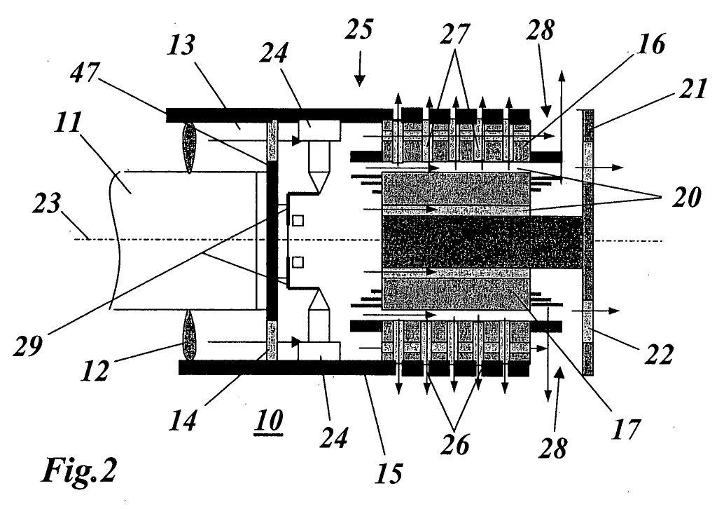

The flow of the cooling medium through the exciter 25, as shown in the exemplary embodiment of FIG. 1, is exclusively axial. However, a radial flow can also be superimposed on this axial flow. FIG. 2 shows an exemplary embodiment of such a mixed axial and radial flow. In addition to the openings and ducts already known from FIG. 1, radial cooling ducts 27 are created in the exciter rotor 16 by using spacers in the laminated core of the exciter rotor 16 through which the cooling medium can flow radially outward and emerge into the space outside the retaining ring 15 via corresponding cooling air openings 26 in the retaining ring 15. Furthermore, a radial cooling air outlet 28 has been left open between the exciter rotor 16 and exciter stator 17 and the mounting wall 21, through which the cooling medium can emerge radially to the outside after flowing axially through the exciter 25. The cooling of the exciter can be adjusted and optimized by the choice of width both of the spacers and of the cooling air outlet 28.

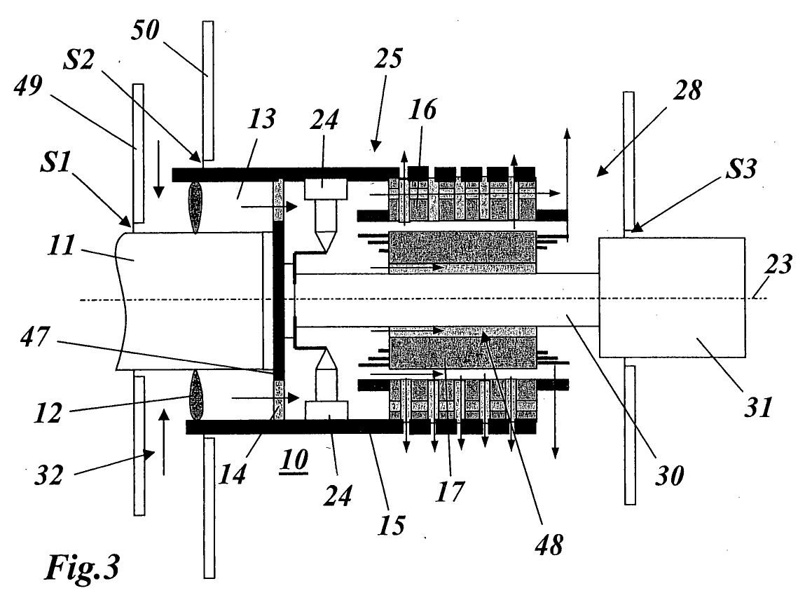

Compared with the exemplary embodiment of FIG. 2, the exemplary embodiment of FIG. 3 has two changes: on the one hand, a radial cooling air inlet 32 has been implemented on the intake side of the fan 12 by corresponding parallel partition walls 49 and 50 which are perpendicular to the axis 23 and are sealed against the rotor shaft 11 and the retaining ring 15 by seals S1 and S2, respectively. On the other hand, a connecting shaft 30 flanged onto the rotor shaft 11 is conducted through a central through bore 48 in the exciter stator 17, which connecting shaft can be connected to another shaft 31 on the other side of the exciter 25 and thus provides for dual drive. The shaft 31 passes through a housing wall and is sealed with a seal S3.

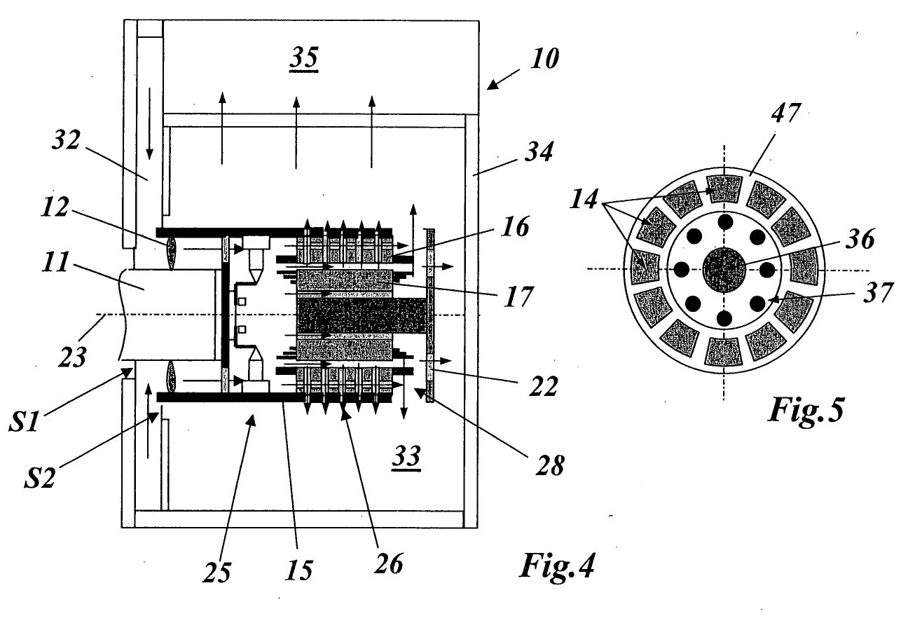

FIG. 4 shows an exemplary embodiment of a cooled exciter in which the exciter 25 according to FIG. 2 is cooled with a separate closed cooling circuit with a radial cooling air inlet 32 according to FIG. 3. For this purpose, the exciter 25 is enclosed by a cooling air housing 34 at a distance, forming a collecting space 33. Above the cooling air housing 34, a cooling device 35 (cooler, heat exchanger or the like) is arranged which is connected at its input with the collecting space 33. The heated cooling medium emerging radially from the cooling air openings 26 and the radial cooling air outlet 28 and axially through the cooling air openings 22 into the collecting space 33 flows in the direction of the arrow into the cooling device 35 where it is cooled again and fed back to the fan 12 via the radial cooling air inlet 32 connected to the cooling device 35 at the outlet end. The cooling circuit for the exciter 25 according to FIG. 4 can be designed and optimized independently of the cooling circuit of the dynamo electric machine.

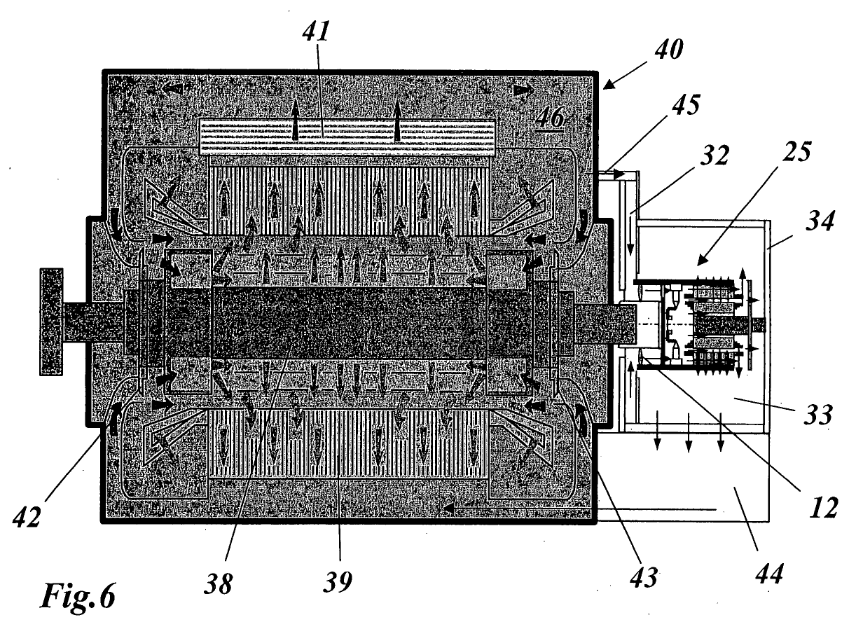

Another simplifying possibility consists in using a cooling device provided for the dynamo electric machine also for the cooling circuit of the exciter. An exemplary embodiment of such a solution is shown in FIG. 6. The dynamo electric machine 40 of the exemplary embodiment has a cooling circuit in which the cooling medium is sucked in from a distribution space 46 located behind the cooling device 41 by two fans 42, 43 arranged at the ends of the rotor 38 and is pushed through the rotor 38 and stator 39 from which it emerges radially and is fed back to the cooling device 41. The exciter 25 has the configuration shown in FIG. 4, with the change that there is no separate cooling device. The cooling medium collected in the collecting space 33 inside the cooling air housing 34 is conducted via a cooling air return 44 to the cooling device 41 of the machine 40 where it is cooled down. A part of the cooled medium located in the distribution space 46 is branched off by means of a connecting channel 45 and supplied to the fan 12 of the exciter cooling circuit via the radial cooling air inlet 32. This results in two superimposed cooling circuits which, however, can be designed independently with respect to their throughput because of the separate fans 42, 43 and 12 respectively.

Overall, the invention results in a simple manner in a separation of the cooling circuits of machine and exciter which provides for separate optimization.

### LIST OF REFERENCE NUMERALS

10, 40 Dynamo electric machine
11 Rotor shaft
12 Fan (axial)
13 Cooling air channel
14 Cooling air opening (retaining ring)
15 Retaining ring
16 Exciter rotor
17 Exciter stator
18 Armature winding
19 Field winding
20 Cooling duct
21 Mounting wall
22 Cooling air opening (mounting wall)
23 Axis
24 Power semiconductor, diode
25 Exciter
26 Cooling air opening (retaining ring)
27 Cooling duct
28 Radial cooling air outlet
29 Connecting conductor
30 Connecting shaft
31 Shaft
32 Radial cooling air inlet
33 Collecting space
34 Cooling air housing
35, 41 Cooling device
36 Central opening
37 Coupling part
38 Rotor
39 Stator
42, 43 Fan
44 Cooling air return
45 Connecting channel
46 Distribution space
47 Wall (retaining ring)
48 Through bore
49, 50 Partition wall
S1, . . . , S3 Seal

1. A dynamo electric machine with a brushless exciter which comprises an exciter rotor driven by the rotor of the dynamo electric machine and an exciter stator interacting with the exciter rotor, wherein the exciter is cooled by a gaseous cooling medium, particularly air, by means of an independent cooling circuit, and wherein a separate fan is provided for circulating the gaseous cooling medium in the cooling circuit of the exciter.

2. The dynamo electric machine as claimed in claim 1, wherein the exciter is arranged axially behind the rotor of the dynamo electric machine and wherein an axially acting fan is provided which conveys the gaseous cooling medium axially through the exciter.

3. The dynamo electric machine as claimed in claim 2, wherein exciter rotor and exciter stator are arranged coaxially with respect to the rotor of the dynamo electric machine, wherein the fan is arranged between the exciter and the rotor, and wherein the fan conveys the gaseous cooling medium axially through the exciter rotor, the exciter stator and the intermediate space between exciter rotor and exciter stator.

4. The dynamo electric machine as claimed in claim 3, wherein the exciter rotor is connected to the rotor shaft of the rotor and wherein the fan is arranged on the rotor shaft or an extension of the rotor shaft.

5. The dynamo electric machine as claimed in claim 4, wherein the exciter rotor encloses the exciter stator concentrically, wherein the exciter rotor is mounted on the inside of a concentric retaining ring, and wherein the retaining ring encloses the fan concentrically, forming an annular cooling air channel between the rotor shaft carrying the fan, or its extension, respectively, and the retaining ring.

6. The dynamo electric machine as claimed in claim 5, wherein the retaining ring comprises a circular-disk-shaped wall which is perpendicular to the axis and arranged between the fan and the exciter, by means of which the retaining ring is mounted on the rotor shaft or the extension, respectively, and wherein cooling air openings are provided distributed over the circumference in the wall, through which the cooling medium can flow axially between the fan and the exciter.

7. The dynamo electric machine as claimed in claim 3, wherein the exciter rotor has an armature winding and the exciter stator has a field winding, and wherein axial cooling ducts, through which the cooling medium flows, are provided in the exciter rotor and in the exciter stator.

8. The dynamo electric machine as claimed in claim 7, wherein, in addition to the axial cooling ducts, radial cooling ducts are provided in the exciter through which the cooling medium flows to the outside.

9. The dynamo electric machine as claimed in claim 6, wherein between the wall and the exciter rotor, on the inside of the retaining ring, power semiconductors interconnected to the exciter are arranged in such a manner that they are located in the flow of the cooling medium passing through the cooling air openings.

10. The dynamo electric machine as claimed in claim 5, wherein the exciter stator is mounted on a mounting wall which is perpendicular to the axis and is arranged axially behind the retaining ring, and wherein, for the outlet of the cooling medium flowing through the exciter, cooling air openings are provided in the mounting wall and/or a radial cooling air outlet is provided between the retaining ring and the mounting wall.

11. The dynamo electric machine as claimed in claim 4, wherein a radial cooling air inlet, through which the cooling medium is supplied to the fan, is provided in front of the fan in the flow direction.

12. The dynamo electric machine as claimed in claim 1, wherein the cooling circuit of the exciter is constructed as a cooling circuit closed in itself and comprises a separate cooling device.

13. The dynamo electric machine as claimed in claim 12, wherein the exciter is enclosed by a cooling air housing which forms a collecting space surrounding the exciter, wherein the cooling device is arranged adjoining the collecting space and wherein the cooling device is connected at its input with the collecting space and at its output with the fan.

14. The dynamo electric machine as claimed in claim 1, whererein the dynamo electric machine has a separate cooling circuit and a separate cooling device and wherein the cooling circuit of the exciter also uses the cooling device of the dynamo electric machine.

15. The dynamo electric machine as claimed in claim 3, wherein the exciter stator has a central through bore in the axial direction and wherein a connecting shaft is carried through the through bore from the rotor of the dynamo electric machine to the other side of the exciter.
